(19) United States
(12) Patent Application Publication
(10) Pub. No.: US 2006/0120449 A1
(43) Pub. Date: Jun. 8, 2006

(54) Method of coding and decoding moving picture

(75) Inventor: Jin Soo Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/294,724

(22) Filed: Dec. 5, 2005

(30) Foreign Application Priority Data
Dec. 6, 2004 (KR) 10-2004-0101690

(51) Int. Cl. H04N 11/04; H04B 1/66; H04N 7/12; H04N 11/02

(52) U.S. Cl. 375/240.2; 375/240.12

(57) ABSTRACT

A method of coding and decoding moving picture is provided. In an image including a first frame in which only a current frame is independently coded without referring to other frames and a second frame(s) referring to other frames, all second frames of GOB (or GOP) is coded, transmitted, and decoded by referring to the first frame.

Pursuant to 35 U.S.C. § 119(a), this application claims the benefit of earlier filing date and right of priority to Korean Patent Application No. 10-2004-0101690, filed on Dec. 6, 2004, the content of which is hereby incorporated by reference herein in its entirety.

### BACKGROUND OF THE INVENTION

1. Field of the Invention

The present invention relates to a method of coding and decoding moving picture.

2. Description of the Related Art

Video codec, such as MPEG1, MPEG2, MPEG4, and H.26x, is widely used in a wireless mobile terminal. For a small amount of computation and maintenance of image quality, a quality of service (QoS) becomes more important than a compression ratio.

Unlike personal computers (PCs), wireless mobile terminals such as portable phone or PDA have limitation in operational capability of processor. Also, the wireless mobile terminals use restricted memory resources. Accordingly, a dedicated hardware or digital signal processor (DSP) have been developed which can process complicated operations, such as moving picture coding and decoding, at low power by using the restricted resources. Recently, algorithm has been more simplified and video codec for new wireless environment has been developed. However, when non-standard video codec is used, it is difficult to maintain compatibility with different terminals in the wireless environment.

Regarding QoS related issues, there are an error resilience field for preventing image quality from being degraded due to error data that is lost or distorted during transmission, and an universal multimedia assess (UMA) field for adaptively transmitting image suitable for a network or terminal environment.

The UMA field will be described below in more detail.

Generally, quality of image can be specified by spatial image quality, frame per second, and resolution. The resolution varies with the number of pixels, for example, quarter common intermediate format (QCIF) (176×144) and quad video graphic array (QVGA) (320×320). The number of frames displayed per second is a factor for determining the degree in which motion appears naturally. Human eyes perceive motion naturally at more than 24 frames per second (fps). Most of mobile terminals have 15 fps or less due to the restricted performance and network bandwidth. The spatial image quality is an image quality when the respective frames are still. If the image quality is increased, the compression ratio is lowered and a large amount of data is to be transmitted. Therefore, the image quality and the compression ratio have to be properly adjusted.

The UMA is a technology that can adaptively change transmission file format in order for compatibility with terminals of different environments and can change specification and transmit it. When changing the specification, three cases can be assumed as follows.

The first case is that terminals have different performance. For example, if a transmit terminal supports VGA (640×480) and a receive terminal supports QVGA (320×240), the transmit terminal transmits data at VGA, th receive terminal has to convert the transmitted data such that it can receive the data at QVGA.

The second case is that the terminals have different specifications. For example, if the transmit terminal has a VGA LCD and the receive terminal has a QVGA LCD, data conversion is required.

The third case is that the network environment is changed. In case where data is transmitted at VGA 15 fps in a 1-Mbps environment, if a receiver side or intermediate point is in a 512-Kbps environment, the receiver side may undergo 50% loss of data or display data slowly because the data are received two times slowly. For solving these problems, a 1-Mbps data size has to be scaled down to a 512-Kbps data size. In this case, the data size can be changed by reducing the resolution or frame rate.

A scalability means that the data size is adaptively adjusted according to the network environment. An adjustment of the resolution is called a spatial scalability, and an adjustment of the frame rate is called a temporal scalability. The spatial scalability is studied in a wavelet based video codec or MPEG4.

A coding method used in MPEG4 will be described below with reference to FIGS. 1 to 3.

Referring to FIGS. 1, in operations S110 and S120, video information is inputted to a buffer and motion estimation is performed on the inputted video information in each macroblock unit. In operation S130, a spatial coding is performed according to a spatial correlation. It is usual that the spatial coding operation S130 includes a discrete cosine transform (DCT) S131 and a quantization S132. In operation S140, an inverse conversion operation is performed on the video information coded in the spatial coding operation S130. The inverse conversion operation S140 includes an inverse quantization S141 and an inverse DCT 142. In operations S150 and S160, after motion compensation is performed, the video information is inputted to a frame buffer. The video information inputted to the frame buffer will be used for configuring the frame together with the video information inputted to the input buffer. At this point, a temporal coding operation is performed using motion vector based on variation of a previous video information and a current video information. Accordingly, the compression ratio for the entire video information is increased. In operations S170 and S180, the video information coded in the spatial coding operation S130 passes through a coding operation S170 and is outputted to an output buffer. The coded video information outputted to the output buffer is stored in a storage unit through an appropriate transmission medium, or transmitted to a desired receiver.

The video coding uses a spatial coding and a temporal coding.

The spatial coding is to compress one frame, like Joint Photographic Expert Group (JPEG). After the DCT is performed for conversion into a frequency domain by units of macroblocks, the coding is performed using Huffman coding or the like. The temporal coding uses the fact that two consecutive frames are not greatly different from each other. The coding is also performed in units of macroblocks. At this point, a partial region corresponding to the most similar macroblocks to a previous frame is found, and a difference between the partial region and a current macroblock is calculated. Then, the DCT is performed on the difference value. In this manner, the coding is achieved. The reason for this is that as the variation of the adjacent pixel values is smaller, the probability that the DCT result will have successive 0 values increases and the compression ratio increases. The motion estimation is an operation that finds the similar partial regions to the previous frame.

In FIG. 1, when the motion estimation is performed with reference to the previous frame, the immediately previous image is referred to. However, MPEG4 introduces a technology that refers to the immediately previous image and the immediately next image. The case where the immediately previous image is called a predicted frame (P frame), and the case where the immediately previous image and immediately next image are called a bi-directional frame (B frame).

In both cases, if error occurs during the transmission and an image quality of one frame is damaged, a next frame referring to the damaged frame is also damaged. This error influences following frames. Therefore, the influence of the damage becomes more serious. This phenomenon is called an error propagation.

In the case of MPEG 4, in order to prevent this phenomenon, an intra frame (I frame) that compresses only the current frame periodically together with the first frame without referring to any frames is inserted. That is, even though the image quality is degraded due to the error, the inserted I frame is newly coded without being influenced by the previous result and is transmitted, so that the error is not propagated any more.

The referring to the I frame, the P frame and the B frame for motion estimation will be described with reference to FIGS. 2 and 3.

FIG. 2 is a view for explaining a method of referring to P frame and B frame in an image including the I frame, the P frame, and the B frame. Specifically, FIG. 2 illustrate an example of a 4-size GOP in which I frame (I210, I220, I230) is inserted to ever four frames [(I210, P211, B210, P211), (I220, P221, B220, P222), (I230, P231, B230, P232)]. In this case, there are two P frames {(P211, P212), (P221, P222), (P231, P232)} and one B frame (B210, B220, B230) and I frame (I210, I220, I230) at each GOP.

Since the B frame (B210, B220, B230) refers to two frames, an amount of computation is larger than other frames. Accordingly, a profile consisting of P frame and I frame is used when a restricted resource is used, like a mobile terminal.

FIG. 3 is a diagram for explaining a method of referring to P frame in an image consisting of I frame and P frame. The P frames P311 to P316 refer to I frame I310 of a current GOB and previous P frames P311 to P315. Accordingly, even though error occurs during image transmission, coding is newly performed from I frame I320 of the next GOBs I1320, P321 to P326, without any reference. Consequently, the image is not influenced by the previous error. In this case, when the user views the displayed images, the image picture appears gradually bad and periodically good. This phenomenon is called a refresh. That is, every when I frame I320 is inserted, the refresh occurs. Accordingly, if I frame is frequently inserted, the refresh period is shortened and thus the image quality becomes good. However, an amount of data to be processed is increased.

### SUMMARY OF THE INVENTION

Accordingly, the present invention is directed to a method of coding and decoding moving picture that substantially obviate one or more problems due to limitations and disadvantages of the related art.

An object of the present invention is to provide a method of coding and decoding moving picture, capable of effectively adjusting frame rate, providing robustness against transmission error, and securing high quality of image.

Another object of the present invention is to provide a method of transmitting moving picture, capable of effectively adjusting frame rate, providing robustness against transmission error, and securing high quality of image.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of coding and decoding moving picture, wherein in a frame group including a first frame in which only a current frame is independently coded without referring to other frames and a second frame referring to other frames, all second frames of the frame group refer to the first frame.

In another aspect of the present invention, there is provided a method of coding and decoding moving picture, wherein in coding and decoding moving picture including first frames in which only a current frame is independently coded without referring to other frames and second frames referring to other frames, the second frame refers to at least two first frames.

In a further another aspect of the present invention, there is provided a method of transmitting moving picture, wherein in a frame group including a first frame in which only a current frame is independently coded without referring to other frames and a second frame(s) referring to other frames, a first frame corresponding to a next frame group is transmitted before second frame(s) of a current frame group is(are) transmitted.

In a further aspect of the present invention, there is provided a method of coding and decoding moving picture, including: coding all P frames of GOB (or GOP) by referring to only I frame of a corresponding GOB (or GOP); and decoding all P frames of the GOB (or GOP) by referring to only I frame of the corresponding GOB (or GOP).

In a further aspect of the present invention, there is provided a method of coding and decoding moving picture, including: coding all B frames of a current GOB (or GOP) by referring to I frame of the current GOB (or GOP) and I frame of another GOB (or GOP); and decoding all B frames of the GOB (or GOP) by referring to I frame of the current GOB (or GOP) and I frame of another GOB (or GOP).

According to the present invention, it is possible to adaptively cope with the network environment and effectively support the temporal scalability for securing compatibility between other terminals and image quality. Also, it is possible to cope with error environment for applications of wireless environment.

In addition, it is possible to prevent error propagation even prior to a refresh. Therefore, the error effect is not influenced on the decoding of the current frame, thereby preventing gradual degradation of image quality.

The coding, decoding and transmitting methods of moving picture according to the present invention can be applied to moving picture compression coding based on block, such as MPEG1, 2, 4, H.263, and H.264, and wireless mobile communication environment. Therefore, moving picture service robust against error can be provided in all applications related to moving picture transmission/reception. Further, by providing the methods that is robust against error propagation and intensifying the error detection, it is possible to provide a mobile video codec, which can effectively adjust the frame rate and provide robustness against error and high quality of image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for explaining a standard encoding method of P frame according to MPEG4;

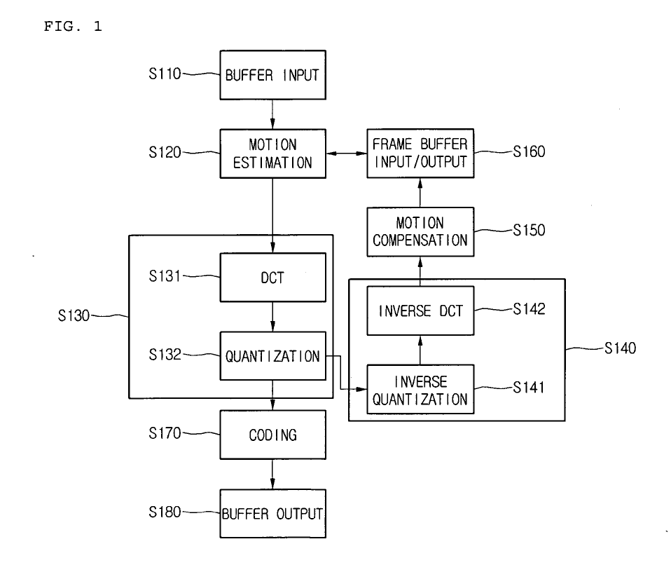

FIG. 2 is a diagram for explaining a method of referring to P frame and B frame in an image consisting of I frame, P frame, and B frame;

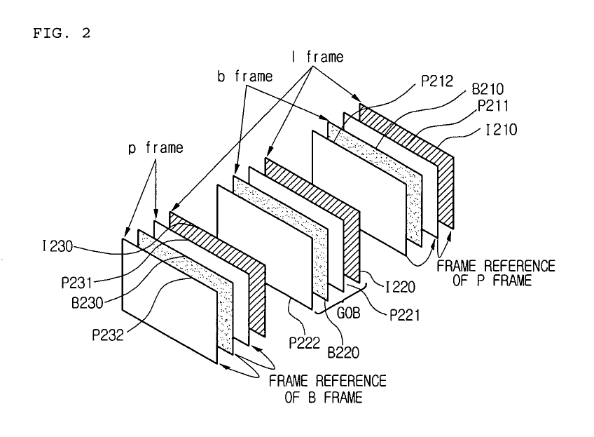

FIG. 3 is a diagram illustrating a method of referring to P frame in an image consisting of I frame and P frame;

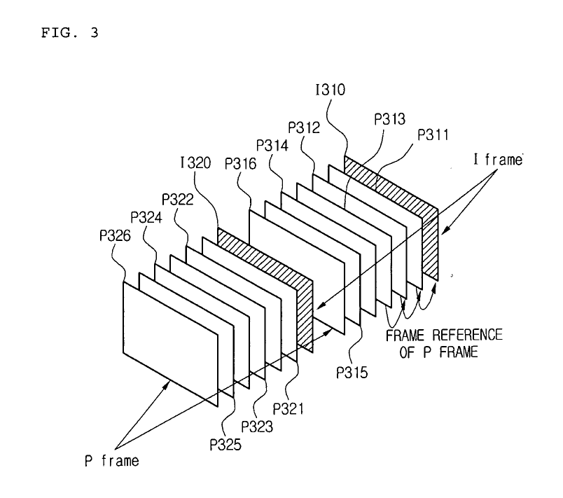

FIG. 4 is a diagram illustrating a method of referring to P frame in an image consisting of I frame and P frame according to an embodiment of the present invention;

FIG. 5 is a diagram illustrating a method of referring to B frame and two I frames in an image consisting of I frame and B frame according to another embodiment of the present invention;

FIGS. 6 and 7 are diagrams illustrating an image transmission sequence when referring to B frame and two I frames.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Although method of coding moving picture, method of transmitting coded moving picture, and method of decoding encoded moving picture according to the present invention can be commonly applied to block-based video codec, such as MPEG1, 2, 4, H.263, H.264, a following description will be made about MPEG4.

In the method of coding and decoding moving picture that consists of I frame coded without referring to other frame and a frame coded by referring to other frame, all P frames of GOB (or GOP) refer to I frames of current GOB. The I frame includes an error detection algorithm using a data hiding so as to error robustness against the corresponding I frame. The error detection algorithm using the data hiding sets a sum of coefficients of DCT block to be even (or odd) in coding, and determines an error when the sum of coefficients in decoding is not even (or odd).

In the method of coding moving picture consisting of I frame coded without referring to other frame and a frame coded referring to other frame, the frame referring to other frame includes B frame referring to two I frames. The two I frames is I frame of a current GOB and I frame of a next GOB.

According to the method of transmitting the coded moving picture, in the case of the frame to be initially transmitted, I frame of a first GOB is transmitted. After I frame of a second GOB is transmitted, B frame of a first GOB is transmitted. Likewise, after I frame of (n+1)th GOB is transmitted, B frame of n-th GOB is transmitted. According to the method of decoding the coded moving picture. I frame of a first GOB in an initial frame and i frame of a second GOB are decoded in sequence. B frames of the first GOB are decoded. From the second GOB on, I frame of (n+1)th GOB is decoded and the B frames of the n-th GOB are decoded.

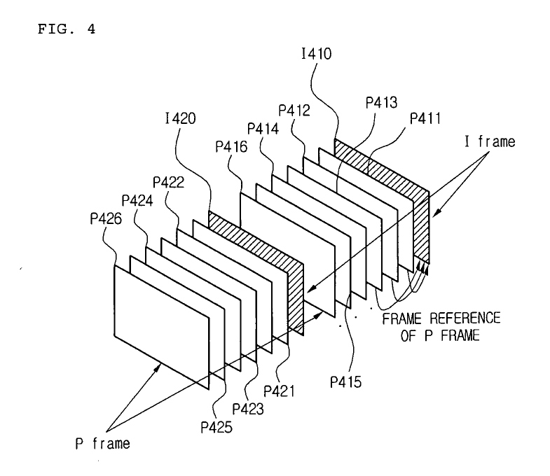

FIG. 4 is a diagram illustrating configuration of P frame (or P picture) in the method of coding moving picture according to an embodiment of the present invention. Video information consists of P frame and I frame (or I picture). Reference symbols I410 and I420 represent I frame, and reference symbols P411 to P416 and P421 to P426 represent P frame. Also, reference symbols I410 and P411 to P416 represent one GOB, and reference symbols I420 and P421 to P426 represent another GOB.

As described above, the gradual degradation of image quality is caused by the referring to the immediately previous frame such that error effect is added at every reference. To prevent this problem, all P frames refer to I frame of the current GOB, instead of referring to the immediately previous frame. That is, the P frames P411 to P416 refer to the I frame I410 of the current GOB, and the P frames P421 to P426 refer to the I frame I420 of the current GOB. In this manner, all P frames refer to the I frame of the current GOB. Therefore, even though error occurs in the P frames, other P frames do not refer to the previous P frame where the error occurs, so that the error is not propagated to other P frames any more.

When all P frames refer to the I frame, whether or not error occur in the I frame is very important. Therefore, it is necessary to reinforce an error robustness tool of the I frame. The compression standard for moving picture proposes several error resilience tool. According to the present invention, the error resilience tool proposed for the error robustness of I frame is applied to the I frame, and an error robustness method using data hiding is additionally applied only to the I frame. The data hiding is a technology that hides desired data while not influencing the original image quality.

In this embodiment, coefficients are set such that their sum becomes even at every DCT block. Therefore, when the coefficient sum becomes odd due to error, it is recognized as error, and the error is corrected. Alternatively, coefficients are set such that their sum becomes odd at every DCT block. Therefore, when the coefficient sum becomes even due to error, it is recognized as error, and the error is corrected.

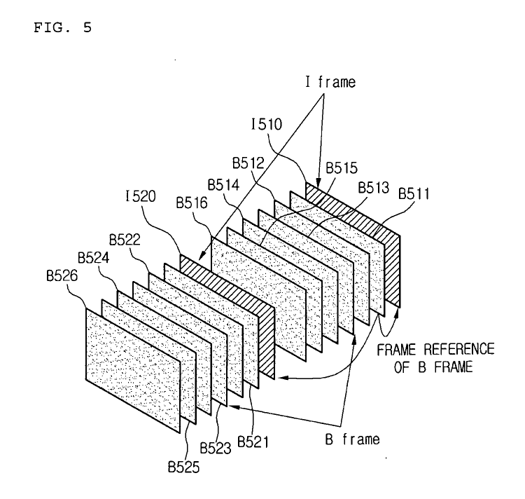

FIG. 5 is a diagram illustrating a method of referring to B frame and two I frames in an image consisting of I frame and B frame (B picture) according to another embodiment of the present invention. Reference symbols I510 and I520 represent I frame, and reference symbols B511 to B516 and B521 to B526 represent B frame. Reference symbols I510 and P511 to B516 represent one Gob, and reference symbols I520 and B521 to B526 represent another GOB.

For more stable error robustness, B frame B511 refers to I frame I510 of the current GOB and I frame I520 of the next GOB. That is, the B frame of the current GOB refers to two I frames, and the current I frames of the two adjacent GOBs are referred to. The B frame refers to two I frames of the temporally adjacent GOB. Therefore, even though large error occurs in one I frame, the error effect is partially divided, thereby obtaining more stable error robustness.

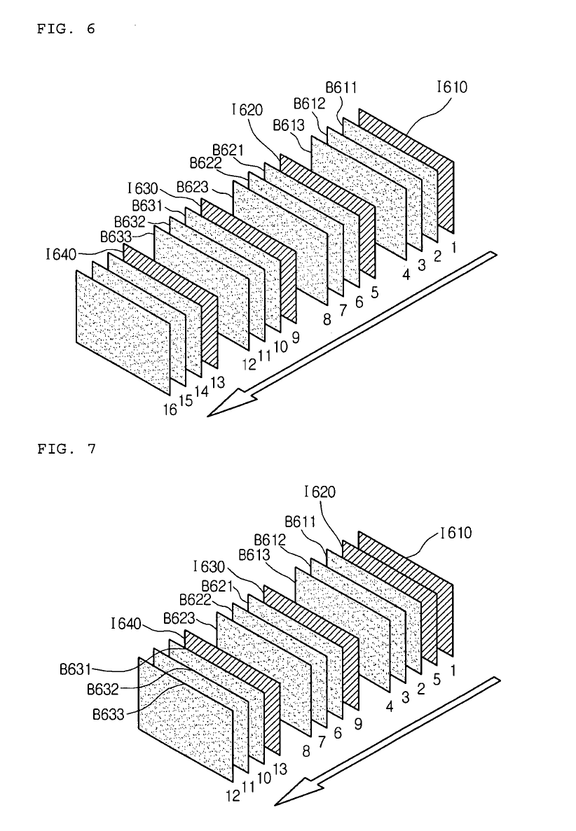

FIGS. 6 and 7 are diagrams for explaining an image transmission sequence according to an embodiment of the present invention. Specifically, the case where B frame refers to two I frames is illustrated.

As illustrated in FIG. 6, the frames configured through the coding process are sequentially transmitted according to the order of the respective frames. That is, I frame I610 of the first GOB is transmitted, and B frames B611, B612 and B613 are sequentially transmitted. After all frames of the first GOB are transmitted, frames of the next GOB are sequentially transmitted in the same manner.

In this case, however, there is not the remaining one picture (i.e., I frame) to be referred by the B frames of the current GOB until the first frame of the next GOB arrives. Therefore, delay occurs in the receiver side.

Accordingly, the first frame is transmitted, and the first frame of the second GOB is transmitted. Then, the B frame of the first GOB is transmitted. From the second GOB on, I frame of the (n+1)th GOB is transmitted, and B frame of the n-th GOB is transmitted.

That is, illustrated in FIG. 7, I frame I610 of the first GOB is transmitted, and I frame I620 of the second GOB is transmitted. Then, before intermediate frames B621, B622 and 623 of the second GOB is transmitted, I frame of the third GOB is first transmitted. Then, intermediate frames B621, B622 and B623 of the second GOB are transmitted. In this case, since the previously transmitted I frame of the second GOB is stored, two I frames to be referred to can be secured when the receiver decompresses the received image signal.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method of coding and decoding moving picture, wherein in a frame group including a first frame in which only a current frame is independently coded without referring to other frames and a second frame referring to other frames, all second frames of the frame group refer to the first frame.

2. The method according to claim 1, wherein the first frame is I frame.

3. The method according to claim 1, wherein the second frame is P frame.

4. The method according to claim 1, wherein the second frame is B frame.

5. The method according to claim 1, wherein the frame group is configured with GOB/GOP unit.

6. The method according to claim 1, wherein an error detection algorithm using a data hiding is applied to the first frame.

7. The method according to claim 1, wherein an error is detected using a sum of coefficients of DCT block with respect to the first frame in coding.

8. The method according to claim 1, wherein a sum of coefficients of DCT block with respect to the first frame in coding is set to even (or odd), and error is detected according to whether a sum of coefficients in decoding is even (or odd).

9. A method of coding and decoding moving picture, wherein in coding and decoding moving picture including first frames in which only a current frame is independently coded without referring to other frames and second frames referring to other frames, the second frame refers to at least two first frames.

10. The method according to claim 9, wherein all of the second frames refer to at least two first frames.

11. The method according to claim 9, wherein the second frame refers to a first frame of a frame group containing the second frame, and a first frame of another frame group.

12. The method according to claim 9, wherein the second frame refers to a first frame of a frame group containing the second frame, and a first frame of a next frame group.

13. The method according to claim 9, wherein the first frame is I frame.

14. The method according to claim 9, wherein the second frame is B frame.

15. The method according to claim 9, wherein the frame group is configured with GOB/GOP unit.

16. The method according to claim 9, wherein an error detection algorithm using a data hiding is applied to the first frame.

17. The method according to claim 9, wherein an error is detected using a sum of coefficients of DCT block with respect to the first frame in coding.

18. The method according to claim 9, wherein a sum of coefficients of DCT block with respect to the first frame in coding is set to even (or odd), and error is detected according to whether a sum of coefficients in decoding is even (or odd).

19. A method of transmitting moving picture, wherein in a frame group including a first frame in which only a current frame is independently coded without referring to other frames and a second frame(s) referring to other frames, a first frame corresponding to a next frame group is transmitted before second frame(s) of a current frame group is(are) transmitted.

20. The method according to claim 19, wherein second frame(s) of an initial frame group is(are) transmitted after the first frame of the initial frame group and the first frame of a next frame group are transmitted.

21. The method according to claim 19, wherein the second frame(s) of the current frame group refers to the first frame of the current frame group and the first frame of the next frame group.

22. The method according to claim 19, wherein the first frame is I frame.

23. The method according to claim 19, wherein the second frame is B frame.

24. The method according to claim 19, wherein the frame group is configured with GOB/GOP unit.

25. A method of coding and decoding moving picture, comprising:
coding all P frames of GOB (or GOP) by referring to only I frame of a corresponding GOB (or GOP); and
decoding all P frames of the GOB (or GOP) by referring to only I frame of the corresponding GOB (or GOP).

26. A method of coding and decoding moving picture, comprising:
coding all B frames of a current GOB (or GOP) by referring to I frame of the current GOB (or GOP) and I frame of another GOB (or GOP); and
decoding all B frames of the GOB (or GOP) by referring to I frame of the current GOB (or GOP) and I frame of another GOB (or GOP).

27. The method according to claim 26, wherein all the B frames of the current GOB (or GOP) refer to I frame of the current GOB (or GOP) and I frame of a next GOB (or GOP).
